(19) United States
(12) Patent Application Publication
(10) Pub. No.: US 2007/0248859 A1
(43) Pub. Date: Oct. 25, 2007

(54) Recuperative exhaust gas processor for a fuel cell system

(76) Inventors: Michael Mihaylov Penev, Colonie, NY (US); Christopher James Chuah, Clifton Park, NY (US); Richard Hayes Cutright, Corinth, NY (US); William A. Shumek, Stony Creek, NY (US)

Correspondence Address: FISH & RICHARDSON PC, P.O. BOX 1022, MINNEAPOLIS, MN, 55440-1022, US

(21) Appl. No.: 11/409,180

(22) Filed: Apr. 21, 2006

(51) Int. Cl. H01M 8/04; H01M 8/06

(52) U.S. Cl. 429/26; 429/20; 429/17

(57) ABSTRACT

Fuel cell systems and methods are disclosed, where the systems include a burner configured to receive a first gas that is exhausted from a fuel cell and to combust the first gas to provide a second gas, and a heat exchanger in fluid communication with the burner, the heat exchanger being configured to receive the second gas from the burner and to transfer heat from the second gas to additional first gas that is exhausted from the fuel cell.

### STATEMENT AS TO FEDERALLY SPONSORED RESEARCH

This invention was made with Government support under NIST Cooperative Agreement Number 70NANBIH3065. The Government has certain rights in this invention.

### TECHNICAL FIELD

This disclosure relates to fuel cells and fuel cell systems that process exhaust gases from fuel cells.

### BACKGROUND

A fuel cell can convert chemical energy to electrical energy by promoting electrochemical reactions between two reactants.

One type of fuel cell includes a cathode flow field plate, an anode flow field plate, a membrane electrode assembly disposed between the cathode flow field plate and the anode flow field plate, and two gas diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each flow field plate has an inlet region, an outlet region and open-faced channels connecting the inlet region to the outlet region and providing a way for distributing the gases to the membrane electrode assembly.

The membrane electrode assembly usually includes a solid electrolyte (e.g., a proton exchange membrane, commonly abbreviated as a PEM) between a first catalyst and a second catalyst. One gas diffusion layer is between the first catalyst and the anode flow field plate, and the other gas diffusion layer is between the second catalyst and the cathode flow field plate.

During operation of the fuel cell, one of the gases (the anode gas) enters the anode flow field plate at the inlet region of the anode flow field plate and flows through the channels of the anode flow field plate toward the outlet region of the anode flow field plate. The other gas (the cathode gas) enters the cathode flow field plate at the inlet region of the cathode flow field plate and flows through the channels of the cathode flow field plate toward the cathode flow field plate outlet region.

As the anode gas flows through the channels of the anode flow field plate, the anode gas diffuses through the anode gas diffusion layer and interacts with the anode catalyst. Similarly, as the cathode gas flows through the channels of the cathode flow field plate, the cathode gas diffuses through the cathode gas diffusion layer and interacts with the cathode catalyst.

The anode catalyst interacts with the anode gas to catalyze the conversion of the anode gas to reaction intermediates. The reaction intermediates include ions and electrons. The cathode catalyst interacts with the cathode gas and the anode reaction intermediates to catalyze the conversion of the cathode gas to the chemical product of the fuel cell reaction.

The chemical product of the fuel cell reaction flows through a gas diffusion layer to the channels of a flow field plate (e.g., the cathode flow field plate). The chemical product then flows along the channels of the flow field plate toward the outlet region of the flow field plate.

The electrolyte provides a barrier to the flow of the electrons and gases from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load, to the cathode flow field plate, and to the cathode side of the membrane electrode assembly.

Electrons are formed at the anode side of the membrane electrode assembly, indicating that the anode gas undergoes oxidation during the fuel cell reaction. Electrons are consumed at the cathode side of the membrane electrode assembly, indicating that the cathode gas undergoes reduction during the fuel cell reaction.

For example, when hydrogen and oxygen are the gases used in a fuel cell, hydrogen flows through the anode flow field plate and undergoes oxidation. Oxygen flows through the cathode flow field plate and undergoes reduction. The specific reactions that occur in the fuel cell are represented in Equations 1-3.
H₂→2H⁺+2e⁻ (1)
½O₂+2H⁺2e⁻→H₂O (2)
H₂+½ O₂→H₂O (3)

As shown in Equation 1, hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in Equation 2, the electrons and protons react with oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

In general, in a first aspect, the invention features a fuel cell system that includes a burner configured to receive a first gas that is exhausted from a fuel cell and to combust the first gas to provide a second gas, and a heat exchanger in fluid communication with the burner, the heat exchanger being configured to receive the second gas from the burner and to transfer heat from the second gas to additional first gas that is exhausted from the fuel cell.

Embodiments of the fuel cell system can include any of the following features.

An outlet of the heat exchanger can be coupled to an inlet of the burner and can be configured to direct the heated first gas to the burner.

The fuel cell system can include an inlet to the burner configured to deliver a third gas to the burner, where the third gas includes an oxidant and the third gas is mixed with the first gas in the burner.

The fuel cell system can include a catalyst coupled to the burner, where the catalyst is configured to catalyze conversion of the first gas to the second gas. The catalyst can be configured to receive gas from the burner and deliver gas to the heat exchanger. The catalyst can include a noble metal such as platinum or other noble metals, for example. Alternatively, or in addition, the catalyst can include other metals such as ruthenium.

The fuel cell system can include a fuel cell anode having an exhaust conduit configured to deliver gas to the heat exchanger.

In another aspect, the invention features a fuel cell system that includes: (a) a fuel cell, including an anode exhaust that is configured to emit a first gas; (b) a reactor for converting the first gas to a second gas; and (c) a heat exchanger that has a first inlet, a second inlet, and a first outlet, where the first inlet is coupled to the anode exhaust and configured to receive the first gas that is emitted from the anode exhaust, the second inlet is coupled to the reactor and configured to receive the second gas emitted from the reactor, and the first outlet is coupled to the reactor and configured to direct the first gas to the reactor. During operation of the fuel cell system, the heat exchanger transfers heat between the first gas emitted from the anode exhaust and the second gas.

Embodiments of the fuel cell system can include any of the following features.

The reactor can include a burner configured to combust the first gas to provide the second gas.

The reactor can include a catalyst configured to promote a reaction of the first gas to form the second gas. The catalyst can include a noble metal or ruthenium.

The heat exchanger can receive the first gas from the anode exhaust at a first temperature, and the reactor can provide the second gas to the heat exchanger at a second temperature, where the second temperature is higher than the first temperature.

In another aspect, the invention features a method that includes reacting a first gas exhausted from a fuel cell anode to provide a second gas that has a higher temperature than the first gas, and heating additional first gas exhausted from the fuel cell anode using the second gas.

Embodiments of the method can include any of the following features.

Reacting the first gas can include combusting the first gas. The method can include combusting the heated additional first gas to provide additional second gas.

Reacting the first gas can include catalyzing a reaction of the first gas. The reaction can be catalyzed using a noble metal or ruthenium.

Reacting the first gas can include oxidizing the first gas.

Reacting the first gas can include mixing the first gas with an oxidant. The method can include varying an amount of oxidant mixed with the first gas to control the temperature of the second gas. The oxidant can be air, for example.

The first gas can be a component of an exhaust gas exhausted by the fuel cell anode, where the exhaust gas has a concentration of about 10% or less (e.g., about 8% or less, about 6% or less, about 4% or less, about 3% or less) of the first gas.

The first gas can be a hydrocarbon. For example, the hydrocarbon can be methane.

Prior to being heated, the first gas can have a temperature in a range from about 100° C. to about 200° C. (e.g., at least about 120° C., at least about 140° C., at least about 160° C., at least about 180° C.). After heating, the first gas can have a temperature in a range from about 250° C. to about 400° C. (e.g., at least about 270° C., at least about 300° C., at least about 330° C., at least about 360° C., at least about 380° C.). Prior to heating the first gas, the second gas can have a temperature of more than about 550° C. (e.g., more than about 600° C., more than about 650° C., more than about 700° C., more than about 750° C., more than about 800° C., more than about 850° C., more than about 900° C.).

Embodiments can include any of the following advantages.

Embodiments include fuel cell systems capable of combusting fuel cell exhaust gas that includes low concentrations (e.g., about 10 mole percent or less, about 8 mole percent or less, about 5 mole percent or less, about 4 mole percent or less, about 3 mole percent or less) of unreacted fuel components (e.g., hydrocarbons). Embodiments include components (e.g., a heat exchanger) that heat fuel cell exhaust gas to a temperature where the unreacted fuel components can readily combust.

Embodiments can include a recuperative heat exchanger, where process heat from the combustion of fuel cell exhaust gas is used to heat additional fuel cell exhaust gas. A recuperative heat exchange configuration can reduce system complexity because separate heating and cooling devices are not used for temperature regulation of fuel cell exhaust gas and combusted fuel cell exhaust gas, respectively. Further, because at least a portion of the heat energy released in the combustion reactions is used within the fuel cell system, the overall energy consumption of the fuel cell system can be reduced relative to systems without recuperative heat exchangers.

Furthermore, embodiments include fuel cell systems with relatively low undesirable emissions. Heating fuel cell exhaust gas prior to combining the fuel cell exhaust gas with oxidant gas and producing combusted fuel cell exhaust gas reduces emissions of certain components in fuel cell exhaust gas, e.g., unreacted fuel components, by a fuel cell system, relative to fuel cell systems where fuel cell exhaust gas is not heated. For example, increasing a temperature of hydrocarbon components such as methane in fuel cell exhaust gas can increase the efficiency of combustion of the hydrocarbon components, thereby increasing a conversation rate of the hydrocarbon components to reaction products such as carbon dioxide, and reducing the amount of unreacted fuel ultimately exhausted into the environment.

Heating fuel cell exhaust gas and increasing the efficiency of combustion reactions can also reduce an amount of catalyst material that is used to initiate and sustain combustion of fuel cell exhaust gas. Embodiments can include one or more catalyst materials that can be used to further increase the efficiency of combustion reactions that convert unreacted fuel components of fuel cell exhaust gas to reaction products, e.g., carbon dioxide. The one or more catalyst materials can be used to promote combustion of unreacted fuel components at a lower temperature than it would otherwise occur in the absence of a catalyst. This enables operation of the fuel cell system at a lower temperature, which is safer than high temperature operation. Further, lower temperature operation of the fuel cell system can be less costly, because high temperature operation (e.g., when combustion reactions are uncatalyzed) may require certain system components to be specially designed and/or manufactured to withstand the high temperatures.

Embodiments can provide control of an output temperature of combusted fuel cell exhaust gas, and can thereby control an output temperature of fuel cell exhaust gas from the heat exchanger. For example, embodiments can include a regulator to adjustably control a flow rate of oxidant gas into a burner, which provides control of the output temperature of the combusted fuel cell exhaust gas because the combustion temperature depends on the amount of oxidant present. Oxidant gas flow rate regulation therefore provides a simple, single-point control for controlling the efficiency of combustion processes.

Regulation of the oxidant gas flow rate can also be used to ensure that an output temperature of the fuel cell exhaust gas from the heat exchanger remains higher than a water condensation temperature. In some fuel cell systems, water can be present in fuel cell exhaust gas, and can deposit in a liquid state on catalyst materials, flooding and poisoning the catalyst materials and reducing the efficiency of combustion of the fuel cell exhaust gas. Maintaining the output temperature of the fuel cell exhaust gas higher than a condensation temperature of water ensures that water present in the fuel cell exhaust gas remains in a gaseous state and does not condense within the catalyst material. Therefore, oxidant gas flow rate regulation provides a simple method for ensuring that process catalysts used in the fuel cell system are not flooded and/or deactivated during operation.

During start-up, oxidant gas supply to an anode side of the fuel cell system can be regulated to prevent deposition of hydrocarbon decomposition products in the heat exchanger. For example, cracking of hydrocarbon components can result in deposition of decomposition products in the heat exchanger, clogging the heat exchanger and preventing its proper operation. Oxidant gas supply to a fuel cell system anode can be increased, thereby ensuring that a fuel cell exhaust gas temperature within the heat exchanger is maintained below a temperature threshold for cracking of one or more hydrocarbon components in the fuel cell exhaust gas.

Heating the fuel cell exhaust gas can also be used to improve combustion efficiency during turn-down operation of a fuel cell system. During turn-down, the amount of heat released from combustion of unreacted hydrocarbon fuel components in fuel cell exhaust gas may be insufficient to maintain a combustion reaction, due to a relatively low concentration of unreacted fuel components in the fuel cell exhaust gas. By heating the fuel cell exhaust gas in the heat exchanger, a sustained combustion reaction can be initiated even during turn-down, thereby preventing discharge of significant amounts of uncombusted fuel components from the fuel cell system.

Unless otherwise defined, all technical and scientific terms used herein have the same meaning as commonly understood by one of ordinary skill in the art to which this invention belongs.

The details of one or more embodiments of the invention are set forth in the accompanying drawings and the description below. Other features and advantages of the invention will be apparent from the description, drawings, and claims.

### DESCRIPTION OF DRAWINGS

FIG. 1 is a schematic diagram of an embodiment of a recuperative exhaust gas processor.

FIG. 2 is a cross-sectional view of an embodiment of a fuel cell.

Like reference symbols in the various drawings indicate like elements.

### DETAILED DESCRIPTION

Fuel cell systems generate exhaust gas during operation. Exhaust gas from fuel cell systems typically includes unreacted fuel (e.g., hydrogen and hydrocarbon compounds such as methane, water, oxidants such as oxygen, and other compounds) at low concentrations (e.g., about 10 mole percent or less). Fuel cell systems can process exhaust gas to remove harmful or otherwise undesirable components from the gas prior to venting the gas to the environment surrounding the fuel cell system. For example, unreacted fuel components such as hydrogen and hydrocarbon compounds, e.g., methane, can be removed from the exhaust gas by converting hydrogen to water and converting the hydrocarbon compounds to carbon dioxide and other products via combustion. An exhaust gas processor can be used to perform these conversion processes.

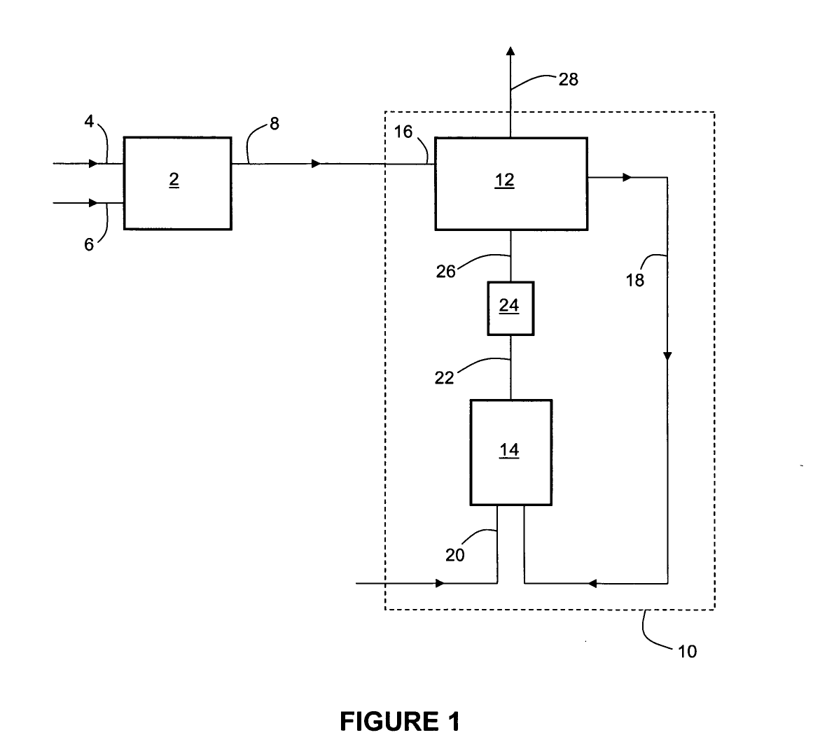

Referring to FIG. 1, a fuel cell system includes a recuperative exhaust gas processor 10 and a fuel cell stack 2. Exhaust gas processor 10 includes a heat exchanger 12, a burner 14, and a catalyst 24. The structure of fuel cell stack 2 is discussed below.

During operation of the fuel cell system, fuel is supplied to fuel cell stack 2 through stack fuel inlet line 4, and oxidant is supplied to fuel cell stack 2 through stack oxidant inlet line 6. Fuel cell exhaust gas emerges from stack exhaust outlet line 8 and enters recuperative exhaust gas processor 10 through an exhaust gas inlet line 16.

The fuel cell exhaust gas flows through exhaust gas inlet line 16 and into heat exchanger 12. Heat exchanger 12 includes a fuel cell exhaust gas flow path (not shown) between exhaust gas inlet line 16 and a heated fuel cell exhaust gas conduit 18. The fuel cell exhaust gas flows along the fuel cell exhaust gas flow path and absorbs heat energy, which raises the temperature of the fuel cell exhaust gas. The heated fuel cell exhaust gas emerges in heated fuel cell exhaust gas conduit 18 and is conveyed to burner 14.

Burner 14 includes an oxidant inlet line 20 through which oxidant gas, e.g., air, enters burner 14. Within burner 14, heated fuel cell exhaust gas and oxidant gas are mixed and ignited. Combustion of unreacted fuel components from the fuel cell exhaust gas can occur in burner 14. A flow rate of oxidant gas through oxidant inlet line 20 is selected, e.g., using a regulator (not shown), so that the oxidant gas is maintained in stoichiometric excess within burner 14 relative to the unreacted fuel components of the fuel cell exhaust gas. As a result of combustion, hydrogen gas in the fuel cell exhaust gas is converted to water, and hydrocarbon components are converted to carbon dioxide and other reaction by-products.

The mixture of fuel cell exhaust gas and oxidant gas is conveyed via a burner conduit 22 to catalyst 24. If conditions within burner 14 alone are insufficient to cause combustion of unreacted fuel components in the fuel cell exhaust gas, then catalyst 24 can be used to initiate and sustain combustion by reducing the activation energy of the combustion processes. Catalyst 24, in combination with the increased temperature provided by heat exchanger 12 to the fuel cell exhaust gas, can be used to control an overall efficiency of combustion of the unreacted fuel components.

The combusted fuel cell exhaust gas, which includes the products of chemical reactions that occur in burner 14 and/or in catalyst 24, in addition to components of the oxidant gas and the fuel cell exhaust gas that do not react, is conveyed via combusted fuel cell exhaust gas outlet line 26 to heat exchanger 12. The temperature of the combusted fuel cell exhaust gas is higher than the temperature of the heated fuel cell exhaust gas in heated fuel cell exhaust gas conduit 18 because the combustion processes that occur in burner 14 and/or catalyst 24 are exothermic. Heat exchanger 12 includes a combusted fuel cell exhaust gas flow path (not shown) between a combusted fuel cell exhaust gas outlet line 26 and a vent line 28. The combusted fuel cell exhaust gas flows along the combusted fuel cell exhaust gas flow path, releasing heat energy to fuel cell exhaust gas flowing along the fuel cell exhaust gas flow path. As a result, the combusted fuel cell exhaust gas emerges at a lower temperature in vent line 28 and is vented to the environment surrounding the fuel cell system.

Heat exchanger 12 provides for transfer of thermal energy between fuel cell exhaust gas and combusted fuel cell exhaust gas. Because process heat generated during combustion of unreacted fuel components is used to increase the temperature of additional fuel cell exhaust gas, heat exchanger 12 is referred to as a recuperative heat exchanger. Recuperative operation of heat exchanger 12 can provide for more efficient operation of the fuel cell system (relative to non-recuperative operation), because thermal energy that would otherwise be dissipated to the system's surroundings is instead used to perform further process functions.

In general, heat exchanger 12 can be any of various types of heat exchangers. For example, heat exchanger 12 can be a tubular heat exchanger or a plate heat exchanger. The parameters of heat exchanger 12, such as fluid capacity, heat exchange surface area, flow capacity, and heat transfer profile, can generally be chosen as desired in order to achieve particular flow rates, temperature control, and other performance metrics in a fuel cell system. Suitable heat exchangers are available, for example, from Dana Long Manufacturing (Toledo, Ohio).

Combustion processes are generally more efficient at higher temperatures, and heating fuel cell exhaust gas in heat exchanger 12 prior to combusting the fuel cell exhaust gas in burner 14 and/or catalyst 24 generally results in more efficient conversion of unreacted fuel components in the fuel cell exhaust gas to reaction products than would otherwise occur without heating. For example, in some embodiments, without heating the fuel cell exhaust gas prior to combustion, about 90% or more of the methane present in the fuel cell exhaust gas may remain uncombusted, and may be vented to the fuel cell's surroundings. Heating the fuel cell exhaust gas in heat exchanger 12 can increase the efficiency of the combustion reaction so that only about 10% or less of the methane initially present in the fuel cell exhaust gas remains uncombusted and is vented.

Catalyst 24 can include one or more catalyst materials suitable for promoting combustion reactions of fuel gas components. Combustion reactions of fuel gas components include oxidation of hydrogen, e.g., by an oxidant such as oxygen, and oxidation of hydrocarbons such as methane, e.g., by an oxidant such as oxygen. Examples of oxidation reactions are given by Equation 3 above for hydrogen, and by Equation 4 for methane:
CH₄+2O₂→CO₂+2H₂O (4)
Suitable catalyst materials can include noble metals such as platinum and gold, for example. Alternatively, or additionally, transition metals such as ruthenium can also be used. Catalysts commonly used in automobile exhaust systems, e.g., catalytic converters, can be used. Catalyst materials are generally available from a wide variety of sources, such as Engelhard Corporation (Iselin, N.J.) and Degussa Corporation (Parsippany, N.J.). In some embodiments, catalyst 24 forms a portion of burner 14. In other embodiments, as shown schematically in FIG. 1, catalyst 24 is provided in a separate unit.

The functioning of catalyst 24 and of heat exchanger 12 with respect to combustion of fuel cell exhaust gas are complimentary. Employing catalyst 24 reduces an activation energy of combustion reactions, so that combustion of fuel cell exhaust gas can occur at lower temperatures than would otherwise occur in the absence of catalyst 24. As a result, the increase in temperature provided by heat exchanger 12 to fuel cell exhaust gas may not be as large in order to enable efficient combustion of fuel cell exhaust gas. In addition, the fuel cell system operates more safely at lower temperatures. However, when heat exchanger 12 provides a relatively larger increase in temperature to fuel cell exhaust gas, a relatively smaller amount of catalyst 24 can be used and efficient combustion can still be sustained. This can lower the cost of a fuel cell system, particularly where expensive noble metal catalysts are used. Thus, the operating temperature range and catalyst materials can generally be chosen together as desired in order to realize particular combustion efficiencies or other fuel cell system performance metrics.

In some embodiments, exhaust gas processor 10 may be operated without burner 14 running, that is, without burner 14 providing a flame to initiate combustion of fuel cell exhaust gas. For example, an increase in temperature provided to fuel cell exhaust gas by heat exchanger 12 may be sufficient to initiate and sustain combustion of fuel components in the fuel cell exhaust gas when the gas is brought into contact with catalyst 24. Heated fuel cell exhaust gas can pass through non-operating burner 14 and undergo combustion in catalyst 24.

Certain embodiments may not include burner 14 at all. For example, heated fuel cell exhaust gas conduit 18 can be connected directly to catalyst 24, and heated fuel cell exhaust gas from heat exchanger 12 can be transported directly to catalyst 24 for combustion therein.

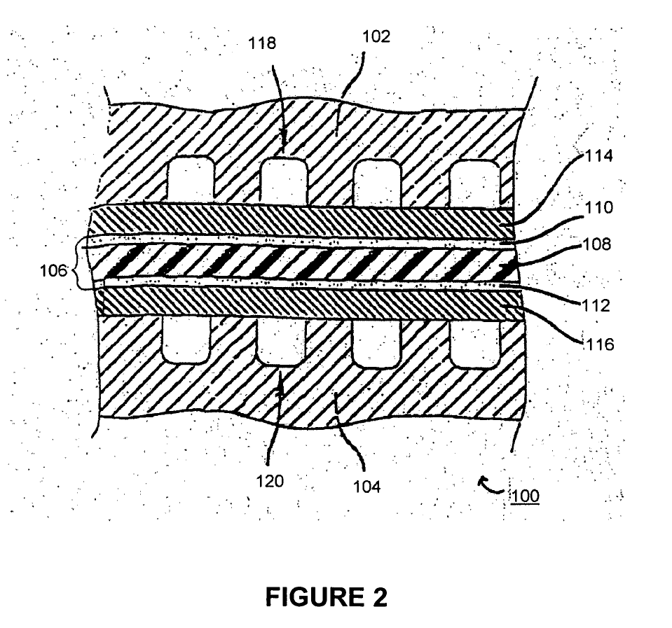

As discussed previously, fuel cell exhaust gas is generated from one or more fuel cells in a fuel cell system. FIG. 2 shows a cross-sectional view of an embodiment of a fuel cell 100. Fuel cell 100 includes a cathode flow field plate 102, an anode flow field plate 104, a membrane electrode assembly 106 having an ion exchange membrane 108, cathode catalyst layer 110, and anode catalyst layer 112. Gas diffusion layers 114 and 116 separate membrane electrode assembly 106 from flow field plates 102 and 104. During operation of the fuel cell, an anode gas is directed to flow through channels 120 in anode flow field plate 104 and a cathode gas is directed to flow through channels 118 in cathode flow field plate 102. The anode gas passes through anode gas diffusion layer 116 and interacts with anode catalyst layer 112. The anode catalyst catalyzes the conversion of anode gas to reaction intermediates. For example, an anode gas including hydrogen can be converted to protons and electrons. The cathode gas passes through cathode gas diffusion layer 114 and interacts with cathode catalyst layer 110. The cathode catalyst catalyzes the conversion of cathode gas to a chemical product of the fuel cell reaction. For example, for an anode gas including hydrogen and a cathode gas including oxygen, the chemical product of the fuel cell reaction can be water, as shown in Equation 3.

In some embodiments, a combination of unreacted fuel components in fuel cell exhaust gas can be inefficient due to the relatively low temperature of the fuel cell exhaust gas as it emerges from the fuel cell stack. Hydrocarbon components such as methane typically do not undergo efficient combustion at temperatures less than about 500° C. For example, methane is efficiently combusted at temperatures between about 550° C. and about 700° C. However, the temperature of fuel cell exhaust gas emerging from an anode side of a fuel cell stack may be only about 170° C., for example. Heat exchanger 12 can be used to increase the temperature of the fuel cell exhaust gas so that efficient combustion of unreacted fuel components can occur. For example, in some embodiments, heat exchanger 12 can be used to increase the temperature of fuel cell exhaust gas by a temperature increment of between about 150° C. and about 200° C. Fuel cell exhaust gas having a temperature of about 170° C. entering heat exchanger 12 exits heat exchanger 12 as heated fuel cell exhaust gas having a temperature of between about 320° C. and about 370° C., for example.

In some embodiments, heating fuel cell exhaust gas prior to initiating combustion of unreacted fuel components in burner 14 and/or catalyst 24 can be used to enable combustion-based removal of fuel components from the fuel cell exhaust gas even when the fuel cell exhaust gas is highly depleted. For example, by increasing the temperature of the fuel cell exhaust gas using heat exchanger 12, combustion in burner 14 and/or catalyst 24 can be sustained when a proportion of combustible components in the fuel cell exhaust gas is about 15 mole percent or less (e.g., about 10 mole percent or less, about 7 mole percent or less, about 5 mole percent or less). Thermal energy provided to the unreacted fuel components by heat exchanger 12 and by the exothermic combustion reactions in burner 14 and/or catalyst 24 are sufficient to sustain combustion even at high depletion levels.

In certain embodiments, the amount of thermal energy transferred to fuel cell exhaust gas in heat exchanger 12 can be regulated by controlling a molar ratio of oxidant gas to fuel cell exhaust gas in burner 14. For example, in some embodiments, oxidant inlet line 20 includes a regulator (not shown in FIG. 1) for controlling a flow rate of oxidant gas in oxidant inlet line 20. Combustion of fuel cell exhaust gas in burner 14 and/or in catalyst 24 is an exothermic process, and combusted fuel cell exhaust gas has a higher temperature than the heated fuel cell exhaust gas entering burner 14. By controlling the ratio of oxidant gas to fuel cell exhaust gas in burner 14, the concentration of unreacted fuel components in the gas mixture can be controlled. Since the oxidant gas is always present in stoichiometric excess in the gas mixture, the amount of heat released during the combustion reaction can therefore be controlled by changing the concentration of unreacted fuel components in the gas mixture. The heat released by the combustion reaction is transported to heat exchanger 12 by combusted fuel cell exhaust gas and transferred to cooler fuel cell exhaust gas emerging from the anode side of the fuel cell stack. Thus, by regulating oxidant gas flow in oxidant inlet line 20, the temperature increase provided by heat exchanger 12 to fuel cell exhaust gas can be adjustably controlled. In some embodiments having a well insulated heat exchanger 12 and fluid transport conduits, the magnitude of the increase in temperature of fuel cell exhaust gas flowing through heat exchanger 12 is approximately equal to the magnitude of the decrease in temperature of the combusted fuel cell exhaust gas flowing through heat exchanger 12.

In some embodiments, regulating oxidant gas flow can also be used to prevent flashbacks in burner 14 and to stabilize a position of the burner flame. Embodiments of burner 14 typically include a flame that is used to ignite the mixture of oxidant and fuel cell exhaust gases. If a concentration of unreacted fuel components in the fuel cell exhaust gas is relatively large, a relatively large amount of heat may be released in burner 14 and/or catalyst 24 during combustion. A portion of the generated heat may contribute to an enhanced rate of combustion by increasing the temperature within burner 14 and/or catalyst 24. As a result, the position of the burner flame can move upstream in burner 14 with respect to the flow of fuel cell exhaust gas, which ignites more readily at elevated temperature. This process of burner flame migration can lead to flashbacks if the flame migrates to a location where the oxidant gas and fuel cell exhaust gas mix. However, by regulating the flow rate of the oxidant gas in oxidant inlet line 20, the stoichiometric ratio of oxidant gas to unreacted fuel components in burner 14 can be controlled and used to counteract flame migration within burner 14 and to prevent flashbacks in the fuel cell system by decreasing the temperature of heated fuel cell exhaust gas entering burner 14.

In certain embodiments, regulating the temperature of fuel cell exhaust gas as it emerges from heat exchanger 12 can also be used to prevent poisoning and/or damage to catalyst 24 due to water condensation. For example, fuel cell exhaust gas can include water, e.g., as a by-product of chemical reactions that occur in fuel cells. At temperatures below about 70° C., water can condense in catalyst 24, flooding the catalyst, poisoning catalyst active sites, and destroying the catalyst's activity. The loss of catalyst activity can lead to drop-out of burner 14, e.g., combustion reactions in burner 14 cease, causing unreacted fuel components to be vented to the fuel cell system's surroundings. By regulating the flow rate of oxidant gas in oxidant inlet line 20, the temperature of fuel cell exhaust gas emerging from heat exchanger 12 can be adjustably controlled. In particular, the temperature of the heated fuel cell exhaust gas can be maintained above a water condensation temperature, e.g., about 70° C., to prevent catalyst flooding and burner drop-out.

During turn-down operation, a fuel cell system operates at less than full capacity, e.g., when demand for electrical power is less than the rated capacity of the fuel cell system. For example, in some embodiments, a fuel cell system can be turned-down to about 50% or less of its rated capacity, or even to about 10% or less of its rated capacity. Under these conditions, concentrations of unreacted fuel components in fuel cell exhaust gas can be sufficiently low that combustion of these components does not produce enough thermal energy to ensure that combustion is sustained. Unreacted fuel components may be vented to the fuel cell system's surroundings. However, by heating the fuel cell exhaust gas in heat exchanger 12 and regulating the flow of oxidant gas in oxidant inlet line 20, sustained and higher-efficiency combustion of unreacted fuel components can be maintained in burner 14 and/or catalyst 24 even during turn-down operation of the fuel cell system, ensuring that high concentrations of undesirable fuel components are not vented externally.

During start-up, a fuel cell system's exhaust gas may contain higher concentrations of unreacted fuel components than during normal operation of the fuel cell, because the system is not yet operating at full capacity. Combustion of this enriched fuel cell exhaust gas may generate additional heat which is conveyed to heat exchanger 12 by the combusted fuel cell exhaust gas. Subsequent fuel cell exhaust gas emerging from the fuel cell stack—and particularly, hydrocarbon components in the emerging fuel cell exhaust gas—can undergo hydrocarbon cracking due to the high temperatures in heat exchanger 12. Cracking can lead to the deposition of decomposition products such as coke in the channels of heat exchanger 12, clogging the channels and impeding fluid flow therein. If the cracking process occurs for an extended period of time, heat exchanger 12 may become too clogged to be effective, and may require costly replacement.

In certain embodiments, oxidant flow in oxidant inlet line 20 can be regulated to prevent hydrocarbon cracking. For example, during start-up, an oxidant flow rate can be increased to increase a stoichiometric ratio of oxidant gas to fuel cell exhaust gas in burner 14, thereby reducing the temperature increase provided to fuel cell exhaust gas by heat exchanger 12. By reducing the temperature increase provided by heat exchanger 12, hydrocarbon cracking can be prevented. In some embodiments, an oxidant gas flow rate to the anode side of the fuel cell stack (e.g., in stack oxidant inlet line 6) can be regulated to further prevent hydrocarbon cracking. For example, the oxidant gas flow rate in stack oxidant inlet line 6 can be increased in order to reduce a concentration and a temperature of unreacted hydrocarbon fuel components in the fuel cell exhaust gas. The oxidant gas can be air, and nitrogen gas in the air can absorb heat from unreacted hydrocarbon fuel components in the fuel cell exhaust gas, cooling the fuel components and reducing the likelihood of hydrocarbon cracking. As an example, when the oxidant gas supplied via stack oxidant inlet line 6 is air, regulating the flow of oxidant gas to produce a molar ratio of oxygen to carbon of between about 0.4 and about 0.8 in the fuel cell exhaust gas can prevent hydrocarbon cracking in heat exchanger 12.

In some embodiments, oxidant gas supplied to burner 14 via oxidant inlet line 20 can be heated in addition to, or in the alternative to, heating fuel cell exhaust gas. A heating apparatus used to heat the oxidant gas can be a heat exchanger. For example, heat exchanger 12 can include further fluid flow paths and can have inlet and outlet lines for transporting oxidant gas through the heat exchanger and heating the oxidant gas therein. Alternatively, the fuel cell system can be provided with a second heat exchanger different from heat exchanger 12. The second heat exchanger can be a recuperative heat exchanger, and process heat from combustion in burner 14 and/or catalyst 24 can be used to heat oxidant gas in the second recuperative heat exchanger. In other embodiments, the second heat exchanger can include a heating element or another device for transferring thermal energy to oxidant gas.

Other embodiments are in the following claims.

What is claimed is:

1. A fuel cell system, comprising:
a burner configured to receive a first gas that is exhausted from a fuel cell and to combust the first gas to provide a second gas; and
a heat exchanger in fluid communication with the burner, the heat exchanger being configured to receive the second gas from the burner and to transfer heat from the second gas to additional first gas that is exhausted from the fuel cell.

2. The fuel cell system of claim 1 wherein an outlet of the heat exchanger is coupled to an inlet of the burner and configured to direct the heated first gas to the burner.

3. The fuel cell system of claim 1 further comprising an inlet to the burner configured to deliver a third gas to the burner, wherein the third gas comprises an oxidant and the third gas is mixed with the first gas in the burner.

4. The fuel cell system of claim 1 further comprising a catalyst coupled to the burner, the catalyst being configured to catalyze conversion of the first gas to the second gas.

5. The fuel cell system of claim 4 wherein the catalyst is configured to receive gas from the burner and deliver gas to the heat exchanger.

6. The fuel cell system of claim 4 wherein the catalyst comprises a noble metal.

7. The fuel cell system of claim 4 wherein the catalyst comprises platinum or ruthenium.

8. The fuel cell system of claim 1 wherein the fuel cell system comprises a fuel cell anode having an exhaust conduit configured to deliver gas to the heat exchanger.

9. A fuel cell system, comprising:
a fuel cell including an anode exhaust that is configured to emit a first gas;
a reactor for converting the first gas to a second gas;
a heat exchanger having a first inlet, a second inlet, and a first outlet, the first inlet being coupled to the anode exhaust and configured to receive the first gas that is emitted from the anode exhaust, the second inlet being coupled to the reactor and configured to receive the second gas emitted from the reactor, and the first outlet being coupled to the reactor and configured to direct the first gas to the reactor,
wherein during operation the heat exchanger transfers heat between the first gas emitted from the anode exhaust and the second gas.

10. The fuel cell system of claim 9 wherein the reactor comprises a burner configured to combust the first gas to provide the second gas.

11. The fuel cell system of claim 9 wherein the reactor comprises a catalyst configured to promote a reaction of the first gas to form the second gas.

12. The fuel cell of claim 11 wherein the catalyst comprises a noble metal or ruthenium.

13. The fuel cell system of claim 9 wherein the heat exchanger receives the first gas from the anode exhaust at a first temperature and the reactor provides the second gas to the heat exchanger at a second temperature, where the second temperature is higher than the first temperature.

14. A method, comprising:
reacting a first gas exhausted from a fuel cell anode to provide a second gas, the second gas having a higher temperature than the first gas; and
heating additional first gas exhausted from the fuel cell anode using the second gas.

15. The method of claim 14 wherein reacting the first gas comprises combusting the first gas.

16. The method of claim 15 further comprising combusting the heated additional first gas to provide additional second gas.

17. The method of claim 14 wherein reacting the first gas comprises catalyzing a reaction of the first gas.

18. The method of claim 17 wherein the reaction is catalyzed using a noble metal or ruthenium.

19. The method of claim 14 wherein reacting the first gas comprises oxidizing the first gas.

20. The method of claim 14 wherein reacting the first gas comprises mixing the first gas with an oxidant.

21. The method of claim 20 further comprising varying an amount of oxidant mixed with the first gas to control the temperature of the second gas.

22. The method of claim 20 wherein the oxidant is air.

23. The method of claim 14 wherein the first gas is a component of an exhaust gas exhausted by the fuel cell anode, where the exhaust gas has a concentration of about 10% or less of the first gas.

24. The method of claim 14 wherein the first gas is a hydrocarbon.

25. The method of claim 24 wherein the hydrocarbon is methane.

26. The method of claim 14 wherein prior to being heated the first gas has a temperature in a range from about 100° C. to about 200° C.

27. The method of claim 14 wherein after heating the first gas has a temperature in a range from about 250° C. to about 400° C.

28. The method of claim 14 wherein prior to heating the first gas, the second gas has a temperature of more than about 550° C.
